(19) United States
(12) Patent Application Publication
(10) Pub. No.: US 2006/0253334 A1
(43) Pub. Date: Nov. 9, 2006

(54) Order placement and acceptance management system

(76) Inventor: Masahiko Fukasawa, Tokyo (JP)

Correspondence Address: KRAMER LEVIN NAFTALIS & FRANKEL LLP, INTELLECTUAL PROPERTY DEPARTMENT, 1177 AVENUE OF THE AMERICAS, NEW YORK, NY, 10036, US

(21) Appl. No.: 10/527,367

(22) PCT Filed: Sep. 15, 2003
(86) PCT No.: PCT/US03/29169

§ 371 Date: Mar. 10, 2005

(30) Foreign Application Priority Data
Sep. 13, 2002 (JP) JP 2002-267734

(51) Int. Cl. G06Q 30/00

(52) U.S. Cl. 705/26

(57) ABSTRACT

An order placement and acceptance management system is presented. In an exemplary embodiment, an order acceptance management apparatus (“OAMA”) receives a predetermined quotation request transmitted by an order placement management apparatus. The OAMA generates a quotation result based on data on products and services which is segmented and stored in a database. The order placement management apparatus (“OPMA”) as well as a transaction management apparatus (“TMA”) store the quotation results transmitted by the OAMA in their own respective storage units, and the OPMA can choose amongst the received quotations to place an order. In an exemplary embodiment, other order placement management apparatuses can also use the quotation results and data on completed transactions which are stored in the transaction management apparatus as reference prices in order to estimate purchase prices for future transactions or evaluate quotations received from OAMAs.

### CROSS REFERENCE TO OTHER APPLICATIONS

This application claims priority to Japanese Patent Application No. 2002-267734, filed on Sep. 13, 2002.

### TECHNICAL FIELD

The present invention relates to electronic commerce (“e-commerce”). In particular, it relates to an apparatus and system which optimizes the placement and acceptance of orders for products and services.

### BACKGROUND OF THE INVENTION

In recent years, commercial transactions effected electronically have become increasingly popular due to the availability of electronic data networks such as the Internet. In particular, in transactions between companies (i.e., “Business to Business” or “B2B” transactions), the use of electronic commerce is expected to substantially increase even further in coming years. This is believed due to a number of reasons. First, electronic commerce makes it possible for both sellers and buyers to reduce their operating costs. Additionally, the availability of an electronic information “superhighway” and numerous associated “virtual marketplaces” makes the task of delivering commercial information to existing customers and finding new customers easier and more immediate.

In inter-company transactions, prices often fluctuate based upon the quantity and/or timing of transactions. They also vary as a function of inventory levels and market supply and demand for the products or services in question. In electronic commerce contexts, where access to multiple buyers and suppliers is available, it is often not the best strategy for a supplier to fix its transaction prices based solely upon a relationship with customers or competitors. It is preferable for suppliers to be able to change prices dynamically in response to business situations and market forces.

On the other side of the transaction, buyers desire to purchase products or services at reasonable prices; ideally at the most reasonable prices then available in the market. It is also desirous for buyers to be able to estimate the prices of future purchases of products or services for budgeting and other planning and forecasting purposes.

Notwithstanding the best of objectives, without some system which can electronically match a variety of potential buyers and sellers together and track all transactions amongst them, it is very difficult to have current market data for (a) sellers to best optimize their pricing instructions, (b) buyers to be able to solicit quotes from a number of sellers substantially simultaneously (“shop around”), or (c) buyers to be able to make meaningful estimates of costs of future purchases or evaluate current quotations as being beneficial or disadvantageous.

Thus, one of the objectives of the present invention is to provide an order placement and acceptance management system, an order placement management apparatus, an order acceptance management apparatus, a transaction management apparatus, and a method for order acceptance or order placements, which can resolve the problems discussed above. Another object of the present invention is to provide an order acceptance management apparatus which can create quotations in formats which are useful to buyers, which contain details important to buyers regarding the goods or services for which quotes are requested, and which allow buyers to perform in-depth analyses of such quotations. A further objective of the present invention is to provide an order placement management apparatus which can use data from past quotations and consummated purchases to estimate transaction prices. Finally, the present invention also aims to provide a transaction management apparatus which can mediate between an order placement management apparatus operated by one or more buyers and an order acceptance management apparatus operated by one or more suppliers.

### SUMMARY OF THE INVENTION

In an exemplary embodiment of the present invention, an order placement management apparatus (“OPMA”) is provided, having a first receiving unit which receives quotation requests, a transmission unit which transmits the quotation requests to a transaction management apparatus, a second receiving unit which receives quotation results presented by suppliers via the transaction management apparatus, and a memory which stores the received quotation results as reference prices. Thus, in accordance with such exemplary embodiment buyers are able to appropriately estimate purchase prices or evaluate quotations received for future transactions by storing all quotation results received as reference prices.

In an exemplary embodiment of the present invention, the order placement management apparatus can be, for example, further equipped with a third receiving unit. This third receiving unit can, for example, receive reference prices from other buyers which can then be maintained by the transaction management apparatus, wherein the memory can, for example, store the reference prices received from other buyers as its own reference prices. In addition, the memory can also, for example, store prices of products or services published by suppliers as reference prices. Additionally, an order placement management apparatus according to an exemplary embodiment of the present invention can be, for example, further equipped with an order placement unit which can generate order placement data. Such data can, for example, identify a supplier who has presented a quotation result, wherein the transmission unit can, for example, transmit the generated order placement data to the transaction management apparatus. Moreover, the order placement management apparatus can be, for example, further equipped with a second memory which can, for example, accumulate consummated order placements as purchase history.

According to an exemplary embodiment of the present invention, the order placement management apparatus can be further equipped with a purchase price estimation unit (or PPEU”). Such a PPEU can, for example, estimate a purchase price based on reference prices stored in a first memory. Alternatively, a PPEU can, for example, estimate a purchase price based on reference prices stored in the first memory and purchase history stored in the second memory.

In an exemplary embodiment of the present invention, an order acceptance management apparatus is provided, having a database in which information on objects, such as offered products and services, is segmented or able to be segmented into a plurality of items and stored, a first receiving unit which receives quotation requests from buyers, a quotation generation unit which retrieves definition files for objects which the quotation requests specify and creates quotation results based on the definition files using the data stored in the database, and a transmission unit which transmits the quotation results to a transaction management apparatus. Using such an order acceptance management apparatus (“OAMA”), very precise and highly transparent quotations can be generated using the segmented data.

In an exemplary embodiment of the present invention, an order acceptance management apparatus can be, for example, further equipped with a second receiving unit which receives order placement data from buyers, as well as a memory which accumulates consummated order placements as sales history. The quotation generation unit can, for example, generate quotation results based on such sales history.

In an exemplary embodiment according to the present invention a transaction management apparatus (“TMA”) can be provided, having a first receiving unit arranged to receive quotation requests from buyers, a forwarding recipient determination unit which can select suppliers who can respond to the quotation requests, a second receiving unit which receives quotation results from the suppliers, and a memory which can accumulate the quotation results for all participating buyers. According to such an exemplary embodiment, not only is the data security of a given buyer improved, but the quotation results generated for such buyer can also be used as reference prices for other buyers using the system by accumulating the quotation results.

In an exemplary embodiment of the present invention, an order acceptance and placement management system can be provided, equipped with an order placement management apparatus, an order acceptance management apparatus, and a transaction management apparatus, wherein the order placement management apparatus and order acceptance management apparatus are networked through the transaction management apparatus. According to such an exemplary embodiment, an order acceptance management apparatus can receive a quotation request transmitted by an order placement management apparatus, and generate a quotation result based on data stored in a database in which segmented information on objects including products and services is stored. Further, the order placement management apparatus and transaction management apparatus can each accumulate the received quotation results in their own respective memories, and each of the other order placement management apparatuses in the system can utilize such quotation results accumulated by the transaction management apparatus as reference prices.

### BRIEF DESCRIPTION OF THE DRAWINGS

FIG. 1 depicts a structural overview of an order placement and acceptance management system according to an exemplary embodiment of the present invention;

FIG. 2 depicts an overview of data inputs and outputs associated with an order placement and acceptance management system according to an exemplary embodiment of the present invention;

FIG. 3 illustrates an exemplary detailed categorization of data associated with “reference prices” of FIG. 2;

FIG. 4 is a process flow chart for order placement and acceptance in an order placement and acceptance management system according to an exemplary embodiment of the present invention;

FIG. 5 is a functional diagram of an order placement management apparatus according to an exemplary embodiment of the present invention;

FIG. 6 depicts comparative tables which illustrate the differences between a quotation generated according to an exemplary embodiment of the present invention (left side of the figure) and a quotation obtained by a conventional method (right side of the figure);

FIG. 7 is a functional diagram of a transaction management apparatus according to an exemplary embodiment of the present invention;

FIG. 8 is a functional diagram of an order acceptance management apparatus according to an exemplary embodiment of the present invention; and

FIG. 9 is a block diagram of a system according to an exemplary embodiment of the present invention showing exemplary hardware components of a transaction management apparatus, an order placement management apparatus, and an order acceptance management apparatus.

### DETAILED DESCRIPTION OF THE INVENTION

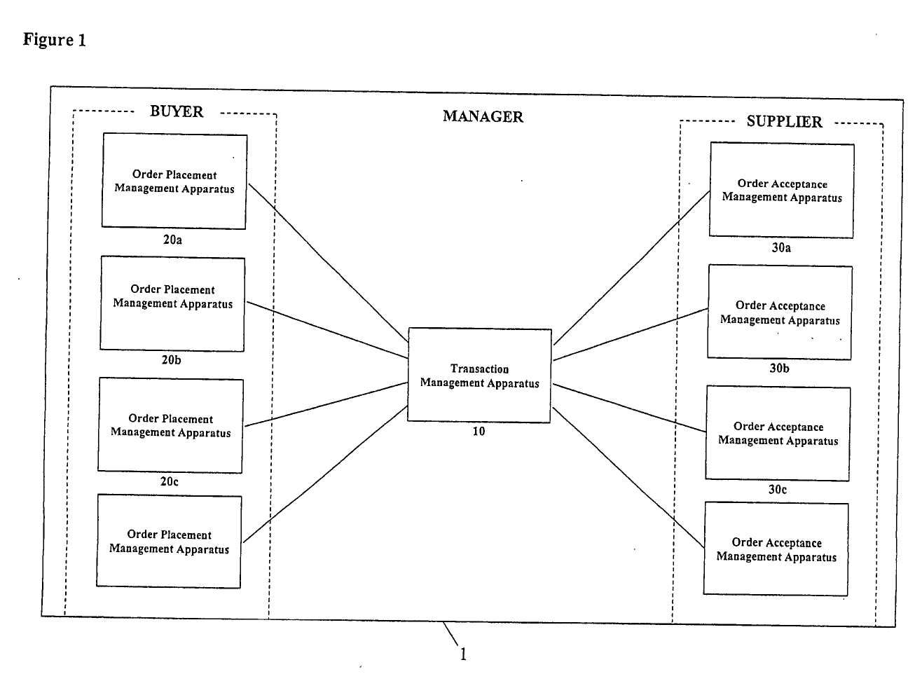

FIG. 1 depicts an overview of an order placement and acceptance management system according to an exemplary embodiment of the present invention. With reference to FIG. 1, order placement and acceptance management system 1 is equipped with a plurality of order placement management apparatuses 20a, 20b, 20c and 20d, a plurality of order acceptance management apparatuses 30a, 30b, 30c, and 30d, and a transaction management apparatus 10 which is connected to each of the OPMAs and OAMAs, respectively. Buyers and suppliers who participate in the order placement and acceptance management system 1 control the order placement management apparatuses 20 and the order acceptance management apparatuses 30, respectively. In exemplary embodiments of the present invention, one buyer controls one order placement management apparatus 20, and one supplier controls one order acceptance management apparatus 30. An administrator of the system can, for example, operate a transaction management apparatus (“TMA”) 10, which can function as a transaction mediator between the various participating buyers and suppliers.

Transaction management apparatus 10 and one or more order placement management apparatuses 20 can be, for example, connected through an electronic data network such as the Internet (or such other substantially simultaneous, paperless data network as may be known in the art), as can be, for example, transaction management apparatus 10 with one or more order acceptance management apparatuses 30. While buyers and suppliers participating in the system are generally business organizations, they are not so limited and could be individuals or other entities as well. Parties which participate in the exemplary order placement and acceptance management system of FIG. 1 can participate either as buyers or suppliers, or both.

Continuing with reference to FIG. 1, the process flow of order placement and acceptance will next be described. An order placement management apparatus 20 can, for example, first transmit a quotation request for some product or service to all order acceptance management apparatuses 30 through transaction management apparatus 10. The quotation request can be, for example, seek a quotation from a supplier in a specific format and having specific content of a buyer's choosing, so as to allow buyers, for example, to acquire detailed information as to products and services offered in the market and to perform detailed analyses using such information. Each order acceptance management apparatus 30 can then, for example, retrieve data related to the quotation request from its own database, generate quotation results using such data, and transmit these results to the requesting order placement management apparatus 20 (through TMA 10). The requesting order placement management apparatus 20 can, for example, receive quotation results from a plurality of order acceptance management apparatuses 30 and select one, that complies with certain defined conditions. Such conditions can include, for example, best price, best terms, best price as weighted by delivery time, etc. Such selection by such exemplary order placement management apparatus can be, for example, carried out under the manual control of a buyer or automatically, according to predetermined business rules or programs of instructions.

The requesting order placement management apparatus 20 can then, for example, generate order placement data and transmit this data to the selected order acceptance management apparatus 30 (again, for example, via TMA 10). Additionally, in exemplary embodiments according to the present invention, order placement management apparatus 20 can accumulate purchase history corresponding to historical quotation results and finalized orders, and use such purchase history for purchase price estimation or quotation price evaluation for subsequent transactions.

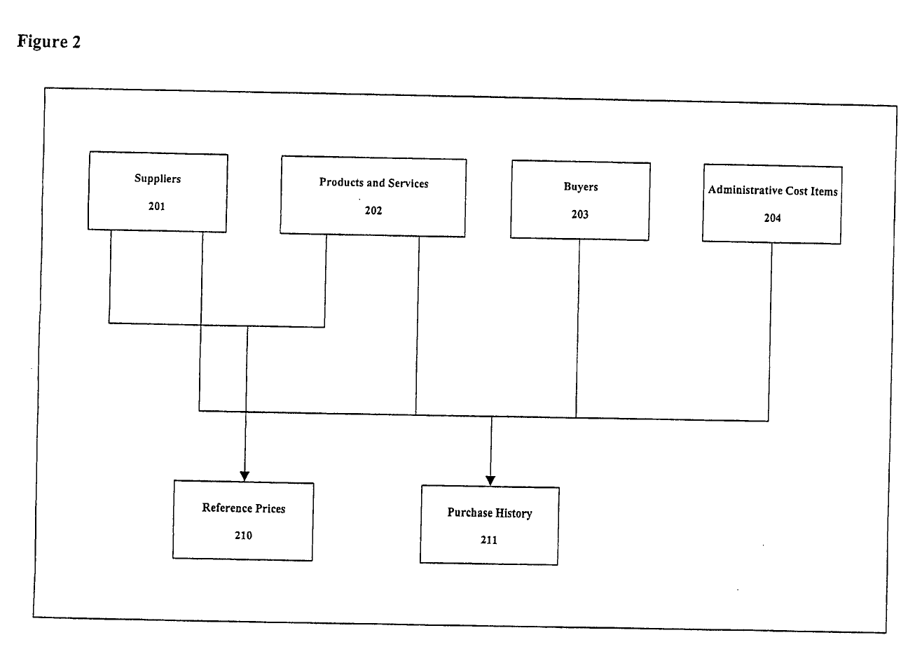

FIG. 2 depicts an exemplary data model which can be used to organize product and service and other data in the exemplary order placement and acceptance management system of FIG. 1. According to this exemplary data model, information related to order placement and acceptance can be divided into six subject areas: “Suppliers” 201, “Products and Services” 202, “Buyers” 203, “Administrative Cost Items” 204, “Reference Prices” 210, and “Purchase History” 211. Under “Suppliers,” entities which define from whom products or services are purchased and with whom negotiations are made can be organized. Under “Products and Services,” data which define the various products and services bought and sold through the system can be organized. Under “Buyers,” data which define persons in charge of payments, negotiations, etc. can be organized. Under “Administrative Cost Items,” data which are related to the tabulation of expenses paid by buyers can be organized. Under “Reference Prices,” data which are related to market prices of products and services can be organized. Finally, under “Purchase History,” data which relate to products and services which were purchased by buyers through the system can be organized. In the exemplary data model of FIG. 2, “Reference Prices” items 210 are created based on inputs from the data in “Suppliers” 201 and “Products and Services” 202. Similarly, “Purchase History” items 211 are created based on inputs from the data contained in “Suppliers” 201, “Products and Services” 202, “Buyers” 203 and “Administrative Cost Items” 204.

Each of the subject areas of FIG. 2 can be managed by at least one of the transaction management apparatus 10, the order placement management apparatuses 20 or the order acceptance management apparatuses 30, as shown in FIG. 1. For example, order placement management apparatus 20 can manage data for the “Buyers,” “Administrative Cost Items,” “Reference Prices,” and “Purchase History” categories. Order acceptance management apparatus 30 can, for example, manage data for “Suppliers” and “Products and Services” categories. Transaction management apparatus can manage, for example, either some or all of the data subject areas. As the categories of FIG. 2 are exemplary only, it is understood by those skilled in the art that numerous other possible classifications of data relating to order placement and acceptance are equivalently implementable.

The information employed can be divided into extremely detailed data without being bound by conventional business practices. Thus, it is possible for both buyers and suppliers to analyze the prices of products and services marketed through the system using detailed data segmentation. To be more concrete, buyers can determine the possibility of a successful price reduction negotiation based on an analysis of segmented quotations, and suppliers can adjust the selling prices of their products and services to be in line with emerging markets trends gleaned from the economic activity of other companies.

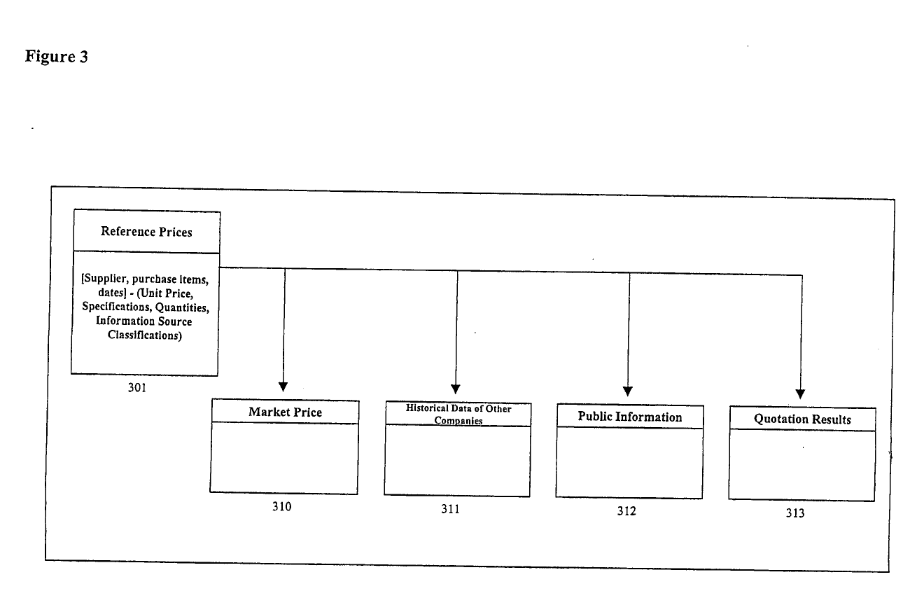

FIG. 3 illustrates an example of data belonging to the subject area of “Reference Prices.” “Reference Prices” 301 have informational connections to, for example, “Market Prices” 310, “Historical Data of Other Companies” 311, “Public Information” 312, and “Quotation Results” 313. Data items from each of these categories can be used, for example, as data inputs for estimating purchase prices by an order placement management apparatus according to an exemplary embodiment of the present invention. It thus becomes possible to appropriately conduct purchase price projections and evaluations of received quotations by classifying data related to reference prices into a number of categories and further segmenting these data items for detailed processing.

For example, “Market Prices” 310 can describe market prices of products and services. “Historical Data of Other Companies” 311 can describe purchase prices experienced by other buyers. This data can be, for example, provided by transaction management apparatus 10 under the authorization of such other buyers, or, for example, it can be provided directly by such other buyers. “Public information” 312 can describe those prices which are available to the public. “Quotation results” 313 can describe quotation prices prepared by multiple suppliers. Using reference prices data available in an exemplary system according to an embodiment of the present invention, buyers can, for example, project a rough price estimate of products or services they are planning to purchase, and in addition they can evaluate the adequacy of any quotation prices which suppliers may provide them. While FIG. 3 illustrates a detailed categorization of data belonging to the subject area of “Reference Prices”, segmented data can also be employed for any subject area shown in the exemplary data model of FIG. 2, or any other relevant subject area as may arise in an exemplary embodiment according to the present invention.

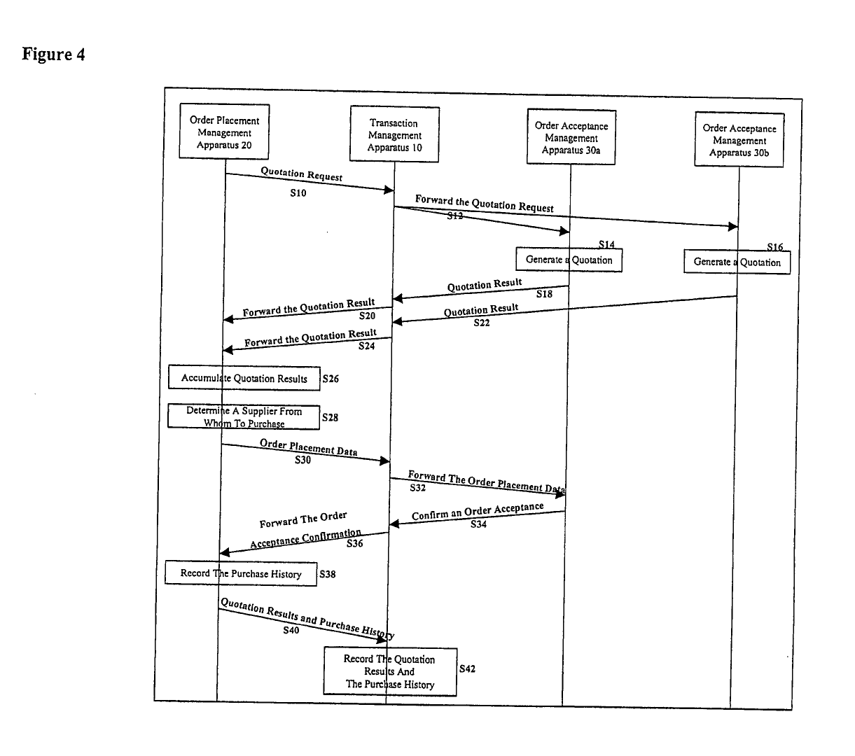

FIG. 4 illustrates an order placement and acceptance process flow according to an exemplary embodiment of the present invention. At S10 order placement management apparatus 20 transmits a quotation request to transaction management apparatus 10. At S12 transaction management apparatus 10 can, for example, search its database for suppliers who offer the products or services described in the quotation request (hereinafter referred to as the “transaction objects”), and forward the quotation request to any relevant suppliers. There are two relevant suppliers depicted in this example, and transaction management apparatus 10 thus forwards the quotation request to each of their respective order acceptance management apparatuses 30a and 30b. At S14 and S16, respectively, each of order acceptance management apparatuses 30a and 30b generates a quotation, and at S18 and S22, respectively, transmits the quotation to transaction management apparatus 10. Transaction management apparatus 10 then forwards the quotation results to order placement management apparatus 20 at S20 and S24, respectively.

Continuing with reference to FIG. 4, at S26 order placement management apparatus 20 accumulates the received quotation results as reference prices. Using such information, buyers are thus able to estimate purchase prices of transaction objects of future purchases based on these reference prices. At S28 buyers can, for example, evaluate a plurality of quotation results and decide from whom to purchase. Or buyers may also, for example, negotiate prices with suppliers through transaction management apparatus 10 based upon evidence that prices are softening. In the depicted example of FIG. 4, the supplier who controls order acceptance management apparatus 30a is chosen by the buyer operating OPMA 20 as the supplier to purchase from.

Accordingly, at S30, order placement management apparatus 20 generates order placement data which specifies a supplier to purchase from, and transmits the data to transaction management apparatus 10. At S32, transaction management apparatus 10 forwards the order placement data to order acceptance management apparatus 30a. Upon receipt of the order placement data, order acceptance management apparatus 30a then confirms the contents of the data at S34 and transmits an order receipt confirmation notice to transaction management apparatus 10. At S36 transaction management apparatus 10 forwards the order acceptance confirmation notice to order placement management apparatus 20, completing the transaction. At S38, order placement management apparatus 20 recognizes that the order acceptance has completed, and records the contents of the order placement as a purchase history item. In this manner, order placement management apparatus 20 can, for example, accumulate quotation results from each supplier as well as the final contents of order placements. At S40 order placement management apparatus 20 transmits the quotation results and purchase history to transaction management apparatus 10, which then records them at S42. The various quotation results and purchase histories recorded in transaction management apparatus 10 can, for example, be made available to other buyers, and in such cases the other buyers can use the data as reference prices.

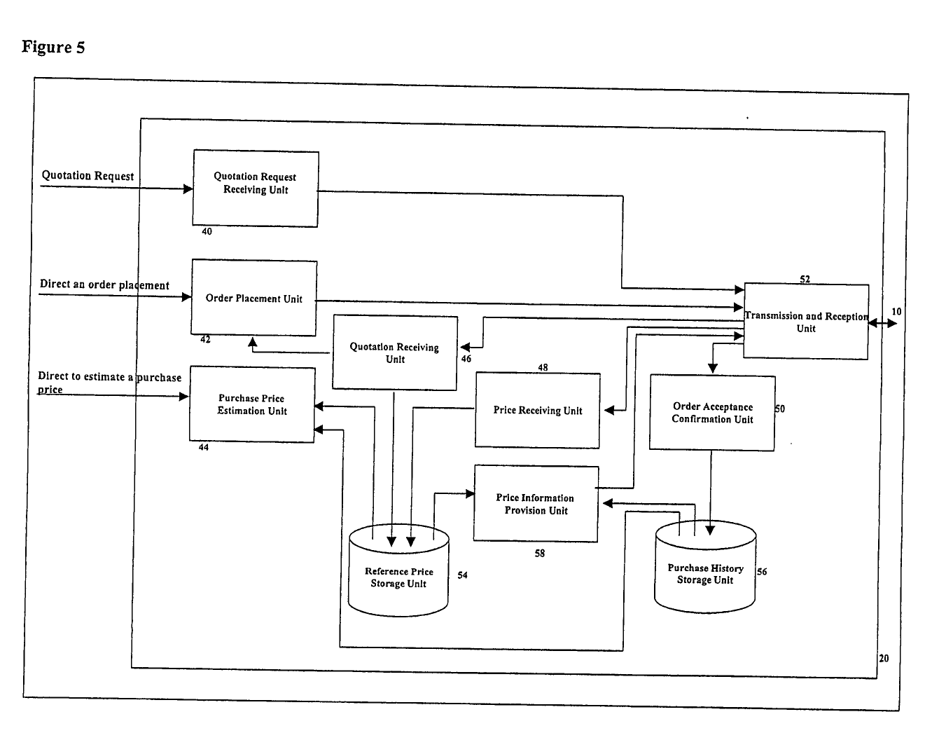

FIG. 5 presents a logical diagram of an exemplary order placement management apparatus 20 according to an exemplary embodiment of the present invention. Order placement management apparatus 20 is equipped with a quotation request receiving unit 40, an order placement unit 42, a purchase price estimation unit 44, a quotation receiving unit 46, a price receiving unit 48, an order acceptance confirmation unit 50, a transmission and reception unit 52, a reference price storage unit 54, a purchase history storage unit 56 and a price information provision unit 58. Transmission and reception unit 52 is arranged to transmit data to and receive data from the outside world. Such an order placement management apparatus 20 can be realized, for example, with a CPU, memory, programs loaded in the memories, etc. It is understood that what is represented in FIG. 5 are functional blocks of an OPMA which can be implemented in various ways as is known in the art. Therefore, the depicted functional blocks can be actualized in various forms using, for example, hardware only, software only, or a combination thereof. The same is also true for order acceptance management apparatus 30 and transaction management apparatus 10, whose logical structures are respectively described below.

To illustrate a transaction that could be effected using a system according to an exemplary embodiment of the present invention, a example transaction object of “moving services” for an employee of a buyer company will next be used. An administrative cost item associated with such a transaction could be, for example, “employee transfer traveling cost”, and could be posted after an order placement.

Continuing with reference to FIG. 5, quotation request receiving unit 40 receives a quotation request from a buyer for moving services. The quotation request can be either generic or concrete. A generic quotation request seeks a table of quoted fees corresponding to various moving distances, number of movers necessary for the job, etc. A concrete quotation request seeks a quotation directed to specific conditions such as, for example, defined moving distance and cargo volume. Such a quotation request can be transmitted from transmission and reception unit 52 to transaction management apparatus 10. A transaction management apparatus can then transmit the quotation request to one or more order acceptance management apparatuses, and forward a quotation result generated at an order acceptance management apparatus back to transmission and reception unit 52.

Once available, quotation receiving unit 46 can receive quotation results presented by a plurality of suppliers through a transaction management apparatus, as described above. Reference price storage unit 54 can, for example, accumulate quotation results as reference prices, relating them to the various suppliers. In addition, quotation results can be displayed on a display device (not shown in FIG. 5) and a buyer can confirm them.

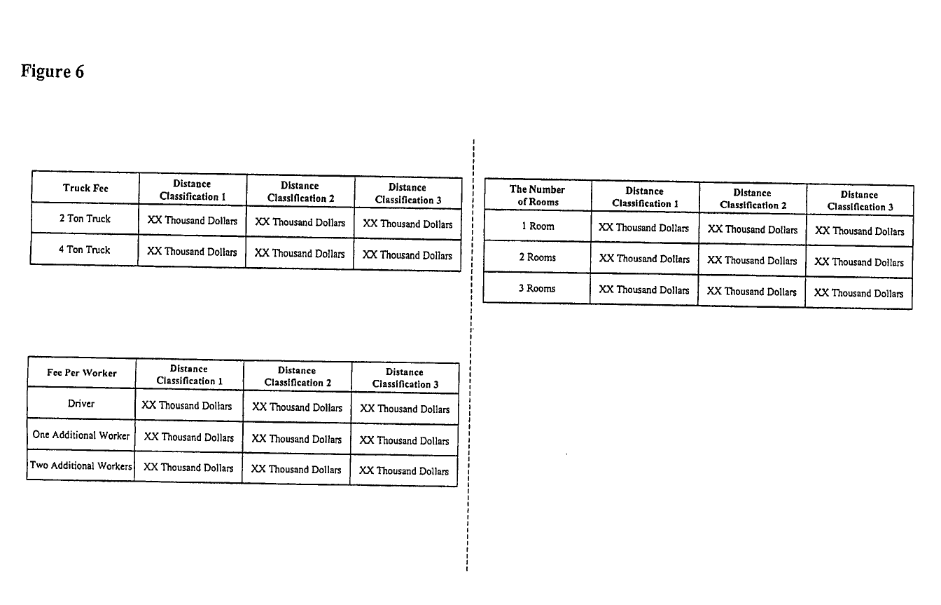

FIG. 6 contains comparative tables which illustrate the differences between quotations for moving services generated using a system according to an exemplary embodiment of the present invention and similar quotations generated by a conventional method. With reference to FIG. 6, exemplary quotations relating to the moving services example introduced above are shown in the left column and a conventional quotation is shown in the right column. In the conventional method, a quotation is generated using a table organized by moving distance and number of rooms, whereas according to an exemplary embodiment of the present invention, a quotation can be generated, for example, using a table of distance and vehicle cost, and a table of distance and unit labor cost. An order acceptance management apparatus (30 in FIG. 1) can generate such a detailed quotation because information related to a transaction object (e.g., moving services) can be classified by the system into very detailed data structures offering a deep look at the quotation data. Consequently, a buyer is able to compare quotation results from a plurality of suppliers, recognize the strengths and weaknesses of each supplier, and choose a supplier after detailed understanding of what the market can offer.

Thus, FIG. 6 is a specific example of the fact that unlike the conventional practice, in exemplary embodiments according to the present invention buyers can specify a variety of detailed formats in which quotations are requested for a given product or service, and can use the detailed data received in response to make a detailed and well informed purchasing decision.

Returning to FIG. 5, after receipt, using an order placement management apparatus according to an exemplary embodiment of the present invention, a buyer can confirm a plurality of received quotation results and decide on a supplier, if any, with whom to place an order. Order placement unit 42 can, for example, receive an order placement direction from a buyer and generate order placement data specifying the supplier who provided the quotation result. A supplier code, which can be included in the quotation result, can also be inserted in the order placement data. Transmission and reception unit 52 can transmit the generated order placement data to a transaction management apparatus. An order acceptance management apparatus operated by the supplier to whom the order is placed can then receive the order placement data and issue an order acceptance confirmation notice. An order acceptance confirmation unit 50 of the order placement management apparatus can, for example, receive the order acceptance confirmation notice through transmission and reception unit 52. After confirming that the order acceptance processes in the relevant order acceptance management apparatus 30 are completed, order acceptance confirmation unit 50 can store the placed order as a purchase history data item in purchase history storage unit 56.

Price receiving unit 48 can, for example, receive market prices, prices published by suppliers as well as reference prices acquired by other buyers, and store them in a reference price database in reference price storage unit 54. Reference prices received by other buyers in the system can be, for example, stored by a system in transaction management apparatus. Thus, quotation results which it has received, market prices, prices by published suppliers as well as reference prices received by other buyers can be stored as reference prices in reference price storage unit 54. Price information provision unit 58 can, for example, transmit reference prices and purchase history to transaction management apparatus 10.

Upon receipt of a purchase price estimation order purchase price estimation unit 44 can, for example, estimate purchase prices based on reference prices stored in reference price storage unit 54. Purchase price estimation unit 44 can, for example, estimate purchase prices based on purchase history stored in purchase history storage unit 56, or it can estimate purchase prices based on reference prices as well as stored purchase history. Such purchase price estimation is useful, for instance, when a buyer desires to understand resource costs in advance for budget management activities, or when a buyer desires to evaluate the appropriateness of received quotation results. When purchase prices are estimated using purchase history in addition to reference prices, highly precise estimation becomes possible because data on actual past transactions is used.

When conducting a concrete purchase price estimation, a buyer can, for example, refer to data items related to a transaction quantity which are included in reference prices or purchase history. For example, a price per unit is usually less when conducting central purchasing, and therefore a given purchase price can be estimated by checking, as to each supplier, whether or not the quantity desired is approved for central purchasing.

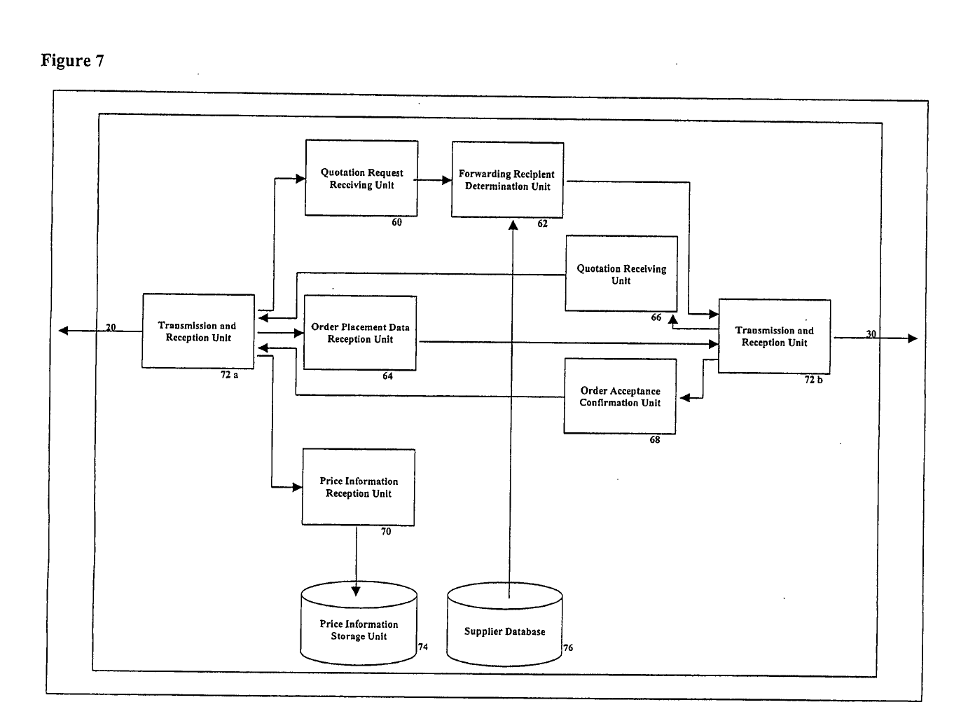

FIG. 7 presents a logical diagram of a transaction management apparatus according to an exemplary embodiment of the present invention. With reference to FIG. 7, a transaction management apparatus can be provided with a quotation request receiving unit 60, a forwarding recipient determination decision unit 62, an order placement data receiving unit 64, a quotation receiving unit 66, an order acceptance confirmation receiving unit 68, a price information receiving unit 70, transmission and reception units 72a and 72b, a price information storage unit 74 and a supplier database 76. Transmission and reception units 72a and 72b are arranged to transmit and receive data, and although they are shown in FIG. 7 as separate unit, they can alternatively be integrated into a single unit as well.

Quotation request receiving unit 60 can, for example, receive a quotation request from a buyer through transmission and reception unit 72a. Forwarding recipient determination unit 62 can then select suppliers from supplier database 76 who can respond to the received quotation request. Here, for example, continuing to use the illustrative example described above, suppliers who operate moving businesses are selected from a plurality of suppliers, and defined as quotation request forwarding recipients. Transmission and reception unit 72b can, for example, transmit the received quotation request to the defined forwarding recipients.

Quotation receiving unit 66 can, for example, receive quotation results from suppliers through transmission and reception unit 72b. Transmission and reception unit 72a can then, for example, transmit the quotation results to an order placement management apparatus 20 as described above. Alternatively, according to an exemplary embodiment of the present invention, quotation receiving unit 66 can also accumulate all received quotation results in a quotation information storage unit (not shown in the exemplary embodiment of FIG. 7). Order placement data receiving unit 64 can, for example, receive order placement data from an order placement management apparatus 20, and can forward the data to a corresponding order acceptance management apparatus 30, as described above. Order acceptance confirmation receiving unit 68 can, for example, receive an order acceptance confirmation notice from an order acceptance management apparatus 30, and can, for example, forward the notice to the requesting order placement management apparatus 20. After the contents of the order placement are finalized by the order placement management apparatus 20, price information receiving unit 70 can, for example, receive reference prices and purchase history from such order placement management apparatus 20, and can, for example, accumulate this data in price information storage unit 74.

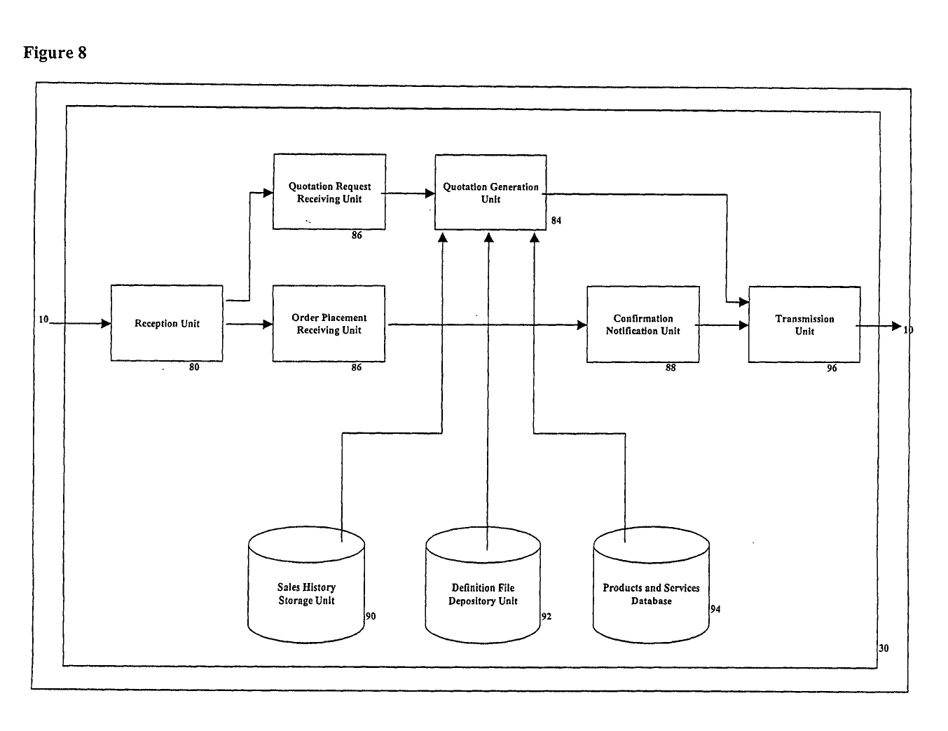

FIG. 8 depicts a logical diagram of an order acceptance management apparatus according to an exemplary embodiment of the present invention. Order acceptance management apparatus 30 can have, for example, a reception unit 80, a quotation request receiving unit 82, a quotation generation unit 84, an order placement data receiving unit 86, a confirmation notification unit 88, a sales history storage unit 90, a definition file depository unit 92, a product and service database 94, and a transmission unit 96. Reception unit 80 can, for example, be arranged to receive data, and transmission unit 96 can, for example, be arranged to transmit data. Product and service database 94 can, for example, store information on transaction objects including products and services offered by suppliers, segmented in a plurality of items.

Quotation request receiving unit 82 can, for example, receive a quotation request from a buyer through reception unit 80. The quotation request can contain information specifying transaction objects such as products or services. Based on this information, quotation generation unit 84 can retrieve definition files, used to generate a quotation for the transaction objects, from definition file depository unit 92. A definition file can, for example, contain data items which are necessary to generate a quotation. Based on the definition files, quotation generation unit 84 can, for example, generate a quotation result using the data stored in product and service database 94. As noted above, segmentation of data items makes it possible to generate a detailed quotation of the type shown in the quotation depicted in the left column of FIG. 6. Finally, transmission unit 96 can, for example, transmit the quotation result to transaction management apparatus 10.

Continuing with reference to FIG. 8, order placement data receiving unit 86 can, for example, receive order placement data from a buyer through reception unit 80. Confirmation notification unit 88 can then, for example generate a confirmation notice that the order placement data has been received, i.e., that the order has been accepted, and can transmit such notice from transmission unit 96. Concurrently, sales history storage unit 90 can accumulate contents of each finalized order acceptance for each buyer as sales history. Additionally, generation unit 84 can also generate a quotation result for each buyer based on the sales history stored in sales history storage unit 90.

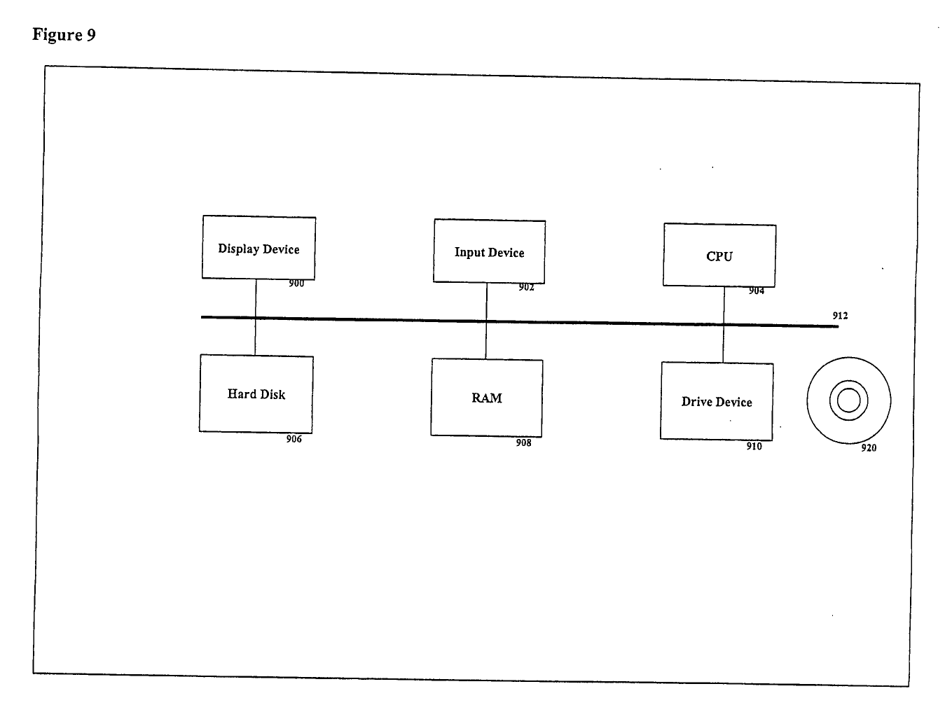

FIG. 9 depicts a block diagram illustrating example hardware components of a transaction management apparatus 10, an order placement management apparatus 20, and an order acceptance management apparatus 30 according to an exemplary embodiment of the present invention. Transaction management apparatus 10, order placement management apparatus 20, and order acceptance management apparatus 30 can each be equipped, for example, with a display device 100, an input device 102, a CPU 104, a bard disk 106, RAM (Random Access Memory) 108, and a drive device 110. These components can be electrically connected through a signal transmission line such as, for example, a bus 112. The structure and function of individual hardware components of an exemplary order placement management apparatus 20 is next presented.

Hard disk 106 can be, for example, a high capacity magnetic recording device, and on it, the exemplary regions described above, such as a reference price storage unit 54 and a purchase history storage unit 56, can be formed. Hard disk 106 can be replaced, for example, with any high-capacity recording device. Recording media 120 can, for example, record programs for CPU 104 to realize various functions of the order placement management apparatus 20 described above. When recording media 120 is inserted in drive device 110, its programs can be retrieved onto hard disk 106 or into RAM 108, and CPU 104 can implement functions such as a quotation demand, an order placement, or a purchase price estimation using such retrieved programs. Recording media 120 can be, for example, a media such as a CD-ROM, DVD, or FD which is readable by a computer.

An example in which order placement programs can be recorded on recording media 120 is explained above. However, in other exemplary embodiments, programs may be transmitted, for example, either via a wireless connection or through wire from an external computer or terminal as well. In the hardware structure illustrated in FIG. 9, the objective of the computer programs is to realize order placement management functions with computers. Thus it is understood by those skilled in the art that not only can programs be externally provided, but also they can be stored on hard disk 106 and form a dedicated machine for an order placement management apparatus 20. The same is true for a transaction management apparatus 10 and an order acceptance management apparatus 30. Thus, the functionalities of OPMAs, OAMAs and TMAs according to various exemplary embodiments of the present invention can be realized in any combination of hardware, software, firmware or the like, as may be desirable in given contexts.

It is further understood that in various exemplary embodiments according to the present invention the intent of a given buyer, supplier or system administrator can be effected by manually operating or controlling an OPMA, OAMA or TMA, respectively, or by preprogramming such OPMA, OAMA or TMA, as the case may be, to operate automatically or semi-automatically, within predetermined parameters or according to predetermined rules. Such automatic or semi-automatic actions can be, for example, implemented via one or more programs of instructions. Thus, any reference to buyer, supplier or administrator action, or to the action of an OPMA, OAMA or TMA in the exemplary embodiments described above is understood to be capable of implementation in a variety of ways, being manual, automatic, semi-automatic or any combination thereof.

The present invention has been explained via various exemplary embodiments. However, the technical scope of the present invention is not limited to any of such examples, it being understood by those skilled in the art that various variations and modifications are possible to each of the individual components, processes, and combinations thereof.

1. An order placement management apparatus, comprising:
a first receiving unit arranged to receive a predetermined quotation request from a buyer,
a transmission unit arranged to transmit the quotation request to a transaction management apparatus;
a second receiving unit arranged to receive quotation results generated by suppliers as a function of the predetermined quotation request; and
a first memory, communicably connected to the second receiving unit, arranged to store the received quotation results as reference prices,
wherein the first and second receiving units are communicably connected to the transmission unit.

2. The order placement management apparatus of claim 1, further comprising a third receiving unit, communicably connected to each of the transmission unit and the first memory, arranged to receive additional reference prices from additional buyers, wherein the first memory additionally stores the additional reference prices as reference prices.

3. The order placement management apparatus of claim 1, further comprising an order placement unit arranged to receive an order replacement request from a buyer and to generate order placement data identifying at least a particular supplier, wherein the order replacement unit is communicably connected to the transmission unit and wherein the generated order placement data is transmitted by the transmission unit to a transaction management apparatus.

4. The order placement management apparatus of claim 1, further comprising a second memory arranged to store accepted orders as purchase history.

5. The order placement management apparatus of claim 1, further comprising a purchase price estimation unit, arranged to receive purchase price estimation requests from a buyer, communicably connected to each of the first and second memories and further arranged to estimate a purchase price based upon reference prices stored in the first memory and/or purchase history stored in the second memory.

6. The order placement management apparatus of claim 1, further comprising an order acceptance confirmation unit, communicably connected to each of the transmission unit and the second memory, arranged to generate a confirmation notice that an order has been accepted by a supplier.

7. The order placement management apparatus of claim 1, further comprising a price information provision unit communicably connected to the first memory and the transmission unit, arranged to provide prices to other buyers in response to specific requests.

8. The order placement management apparatus of claim 1, wherein a predetermined quotation request includes a request wherein a buyer can specify the format and content of quotations to be generated by suppliers in response to the predetermined quotation request.

9. An order acceptance management apparatus, comprising:
a database in which information on offered objects is segmented and stored as a plurality of data items;
a first receiving unit arranged to receive a predetermined quotation request from a buyer;
a quotation generation unit, communicably connected to the first receiving unit, arranged to retrieve definition files for an object specified by the quotation request and to generate a quotation result based on said definition files, and
a transmission unit arranged to transmit the quotation results to a transaction management apparatus.

10. The order acceptance management apparatus of claim 9, further comprising a second receiving unit arranged to receive order placement data from buyers.

11. The order acceptance management apparatus of claim 9, further comprising a first memory, communicably connected to the quotation generation unit, arranged to store finalized order placements as sales history.

12. The order acceptance management apparatus of claim 9, further comprising a second memory communicably connected to the quotation generation unit, arranged to store the definition files.

13. The order acceptance management apparatus of claim 11, wherein said quotation generation unit generates quotation results as a function of the sales history stored in the first memory.

14. The acceptance management apparatus of claim 10, further comprising a reception unit, communicably connected to each of the first and second receiving units, arranged to receive incoming requests from the transaction management apparatus and route them to one of the first or the second receiving units.

15. The order acceptance management apparatus of claim 9, wherein a predetermined quotation request includes a quotation request wherein a buyer can specify the format and content of quotations to be generated by suppliers in response to the predetermined quotation request.

16. A transaction management apparatus, comprising:
a first receiving unit arranged to receive predetermined quotation requests from buyers,
a forwarding recipient determination unit communicably connected to the first receiving unit arranged to select suppliers who could respond to the predetermined quotation requests;
a second receiving unit arranged to receive quotation results from the suppliers and transmit them to requesting buyers; and
a first memory arranged to store data regarding suppliers.

17. The transaction management apparatus of claim 16, further comprising a third receiving unit, arranged to receive order placement data from buyers and transmit the order placement data to suppliers.

18. The transaction management apparatus of claim 16, further comprising a price information reception unit and a second memory, wherein the price information unit is arranged to receive reference price data and purchase history from a buyer and the second memory is arranged to store said reference price data and purchase history and make said reference price data and purchase history available to order placement management apparatuses.

19. The transaction management apparatus of claim 16, further comprising an order acceptance confirmation unit arranged to receive an order acceptance confirmation notice from an order acceptance management apparatus and to forward said notice to an order placement management apparatus.

20. The transaction management apparatus of claim 16, further comprising a transmission and reception unit, arranged to manage all received and transmitted data.

21. An order acceptance and placement management system, comprising:
one or more order placement management apparatuses;
one or more order acceptance management apparatuses; and
a transaction management apparatus,
wherein each of said order placement management apparatuses and said order acceptance management apparatuses are networked through said transaction management apparatus, and
wherein an order acceptance management apparatus is arranged to receive a predetermined quotation request determined transmitted by a requesting order placement management apparatus, and to generate a quotation result based on a database in which data on offered objects is stored, and
wherein said requesting order placement management apparatus and said transaction management apparatus each accumulate quotation results and purchase history in one or more memories.

22. The system of claim 21, wherein one or more order placement management apparatus can utilize the quotation results and purchase history accumulated by said transaction management apparatus as reference prices.

23. The system of claim 21, wherein a predetermined quotation request includes a quotation request wherein a buyer can specify the format and content of quotations to be generated by suppliers in response to the predetermined quotation request.

24. The system of claim 23, wherein a buyer uses stored quotation results and purchase history to evaluate a quotation result.

25. The system of claim 23, wherein a buyer uses stored quotation results and purchase history to perform a detailed analysis of market trends and evaluate a potential for negotiating a better quotation result from a supplier.

26. The system of claim 23, wherein a placement management apparatus, an order acceptance management apparatus or a transaction management apparatus can be implemented in hardware, software, or in any combination thereof.
